(19) United States
(12) Patent Application Publication
(10) Pub. No.: US 2009/0029707 A1
(43) Pub. Date: Jan. 29, 2009

(54) APPARATUS AND METHOD FOR COMMUNICATION IN WIRELESS COMMUNICATION NETWORK USING GLOBAL RADIO RESOURCE CONTROLLER

(76) Inventors: Rehan Jalil, San Jose, CA (US); Mustafa Ergen, Oakland, CA (US)

Correspondence Address: Global IP Services, PLLC;3rd Block, 198 F, 27th Cross, Jayangar, Bangalore-560011, Karnataka, IN

(21) Appl. No.: 12/177,894

(22) Filed: Jul. 23, 2008

Related U.S. Application Data
(60) Provisional application No. 60/961,800, filed on Jul. 23, 2007.

(51) Int. Cl. H04Q 7/00

(52) U.S. Cl. 455/436; 370/331

(57) ABSTRACT

A method, system, and apparatus for communication in a wireless communication network by using a global Radio Resource Controller is provided. The method includes receiving one or more reports from one or more local RRCs by the global RRC. The method further includes sending one or more responses to each of the one or more local RRCs by the global RRC. The one or more responses correspond to the one or more reports received from the one or more local RRCs.

### RELATED APPLICATIONS

Benefit is claimed under 35 U.S.C. 119(e) to U.S. Provisional Applications Ser. 60/961,800 entitled “Apparatus and method for communication in wireless communication network using Global Radio Resource Controller” by Rehan Jalil et al., filed on 23rd Jul. 2007, which is herein incorporated in its entirety by reference for all purposes.

### FIELD OF THE INVENTION

The invention generally relates to a wireless communication network. More specifically, the invention relates to method, system and apparatus for providing wireless communication using a Global Radio Resource Controller (RRC).

### BACKGROUND OF THE INVENTION

In a wireless communication network such as a Worldwide Interoperability for Microwave Access (WiMAX) communication network, an Access Service Network (ASN) forms the radio access network. The ASN includes one or more ASN-Gateways (ASN-GWs) and a plurality of Base Stations (BSs). The plurality of BSs are further in communication with a plurality of Mobile Stations (MSs). Each ASN-GW interfaces with one or more BSs in the ASN. The ASN enables functions such as Radio Resource Management (RRM) and Handover Management (HOM) for efficient communication in the wireless communication network.

In RRM, parameters related to radio transmission between the one or more BSs are controlled. These parameters for example, can be, transmitting power, channel allocation, handover criteria, modulation scheme and error coding scheme. RRM enables effective utilization of the radio spectrum and network resources during communication in a wireless communication network. On the basis of RRM and requirements in the wireless communication network, the Handover Management (HOM) of the resources is performed.

These functions are enabled using various existing profile architectures in the wireless communication network. Two of these profile architectures are the profile A (centralized) and the profile C (distributed) architectures. The profile A is a centralized architecture where the ASN-GW includes an RRC and a BS in the wireless communication network includes a Radio Resource Agent (RRA). A RRA reports about the spare capacity and PHY requirements of the corresponding BS to the RRC in the ASN-GW. Based on the information, the RRC performs RRM and HOM in a centralized manner. However, the profile A results in heavy overloading of the ASN-GW. Additionally, the profile A architecture is less efficient in catering services of many vendors in the wireless communication network to the one or more MSs because this overloads the ASN-GW.

Contrary to the profile A, the profile C is a distributed architecture where each BS of the plurality of BSs includes a RRC operatively coupled with an RRA. The ASN-GW includes a Radio Resource Relay (RRR). In the Profile C, a RRC in a BS interacts only with one or more RRCs in one or more neighboring BSs. This interaction may be facilitated by the RRR in the ASN-GW. Therefore, a BS in the profile C architecture only has information (for example, spare capacity) corresponding to one or more neighboring BSs. As a result of this, during a handover, a BS may be simultaneously transferred load by two BS. The two BSs are neighbors of the BS but do not interact with each other. This may result in over-loading the BS, which earlier had spare capacity. Additionally, the profile C architecture requires extra backhauls for the transfer of information between the various BSs in the wireless communication network.

There is a therefore, a need for a method and system for communication in the wireless communication network using an architecture which facilitates communication between the various BSs by avoiding overload at the ASN gateway. Also the architecture should facilitate efficient load balancing amongst the various BSs without extra backhauls for transferring the information.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a block diagram showing a wireless communication network in which various embodiments of the invention may function.

FIG. 2 is a block diagram showing a system for communication in a wireless communication network, in accordance with an embodiment of the invention.

FIG.3 is a block diagram showing an apparatus for managing communication in a wireless communication network, in accordance with an embodiment of the invention.

FIG. 4 is a flowchart of a method for communication in a wireless communication network, in accordance with an embodiment of the invention.

FIG. 5 is a flowchart of a method for performing handover in a wireless communication network, in accordance with an embodiment of the invention.

FIG. 6 is a flowchart of a method for performing handover in a wireless communication network, in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to a Global Radio Resource Controller (RRC) in a wireless communication network. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide apparatus, method, and system for communication in wireless communication network using a global Radio Resource Controller (RRC). The method includes receiving one or more reports from one or more local RRCs by the global RRC. The method further includes sending one or more responses to each of the one or more local RRCs by the global RRC. The one or more responses correspond to the one or more reports received from the one or more local RRCs.

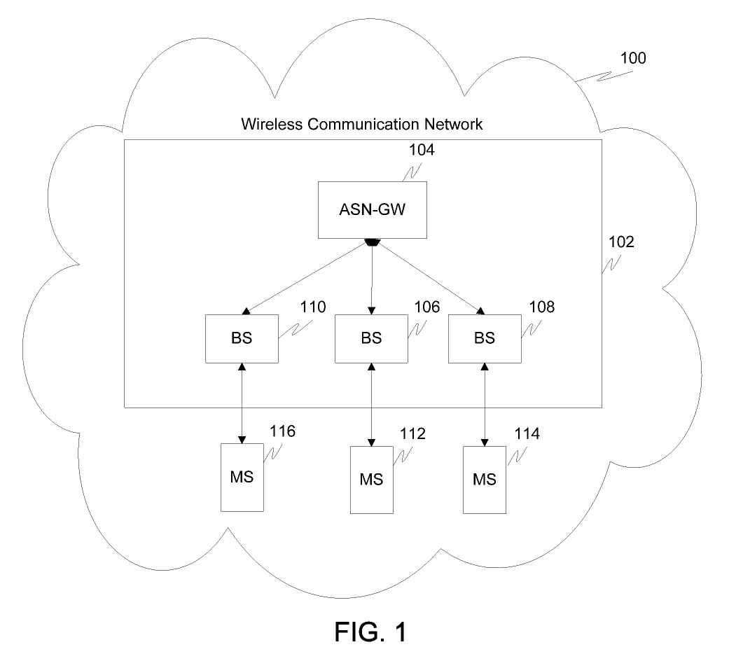

FIG. 1 is block diagram showing a wireless communication network 100 in which various embodiments of the invention may function. Examples of wireless communication network 100 may include, but are not limited to Wireless Interoperability Microwave Access (WiMAX) communication network, 3rd Generation Partnership Project (3GPP) Long Term Evolution (LTE) network, 3rd Generation Partnership Project 2 (3GPP2) Ultra Mobile Broadband (UMB) network, Wireless Fidelity (WiFi) network, and Orthogonal Frequency Division Multiple Access (OFDMA). Wireless communication network 100 includes an Access Service Network (ASN) 102. It will be apparent to a person skilled in the art that wireless communication network 100 may include more than one ASN.

ASN 102 includes an ASN-Gateway (ASN-GW) 104 and a plurality of BSs, such as, BS 106, BS 108, and BS 110. It will be apparent to a person skilled in the art that ASN 102 may include more than one ASN-GW. ASN-GW 104 communicates with the plurality of BSs to perform various functions in ASN 102. Examples of these functions may include, but are not limited to Authorization, Authentication, Accounting (AAA), Portfolio Management, Radio Resource Management (RRM), and Handover Management (HOM).

A BS in the plurality of BSs is capable of communicating with one or more neighboring BSs in wireless communication network 100. For example, BS 106 and BS 108 may be neighboring BSs. In this case, BS 106 and BS 108 are capable of communicating amongst each other. This communication between BS 106 and BS 108 may be relayed through ASN-GW 104. Further, the plurality of BSs communicate with a plurality of Mobile Stations (MSs). For example, BS 106 communicates with a MS 112, BS 108 communicates with a MS 114, and BS 108 communicates with a MS 116 to provide various communication services to MS 112, MS 114, and MS 116 in ASN 102. Examples of a MS may include, but are not limited to a laptop computer and a hand-held device using which a subscriber avails various communication services.

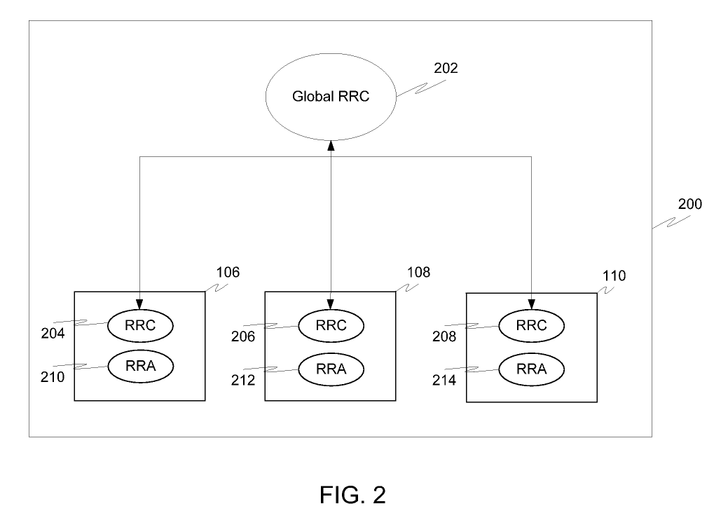

FIG. 2 is a block diagram showing a system 200 for communication in wireless communication network 100, in accordance with an embodiment of the invention. In an embodiment of the invention, wireless communication network 100 may be a WiMAX communication network. In this case, system 200 is located in ASN 102. In another embodiment, wireless communication network 100 corresponds to profile C network architecture of a WiMAX communication network. System 200 includes a global Radio Resource Controller (RRC) 202 and one or more local RRCs, such as, a local RRC 204, a local RRC 206, and a local RRC 208.

Global RRC 202 may be located in an ASN-GW, such as, ASN-GW 104. Alternatively, global RRC 202 may be located in a master BS. The master BS may be selected from the plurality of BSs in wireless communication network 100. It will be apparent to a person skilled in the art that any other network entity in wireless communication network 100 may include global RRC 202. Global RRC 202 communicates with the one or more local RRCs for exchanging information about wireless communication network 100. The information exchanged may include, but is not limited to a PHY parameter report, a spare capacity report, a contextual report, a data path report, and a handover report. The one or more RRCs are further operatively coupled to one or more local RRAs. For example, local RRC 204 is operatively coupled with a local RRA 210, local RRC 206 with a local RRA 212 and local RRC 208 with a local RRA 214.

The plurality of BSs include the one or more local RRCs operatively coupled with the one or more local RRAs. For example, BS 106 includes local RRC 204 and local RRA 210.BS 108 includes local RRC 206 and local RRA 212 and BS 110 includes local RRC 208 and local RRA 214. In a BS, a local RRA receives network information from the corresponding local RRC and makes this network information available to the corresponding BS. Further, the local RRA provide measurements related to radio resources to the corresponding local RRC. For example, local RRA 210 receives network information from local RRC 204 and provides it to BS 106. Additionally, local RRA 210 performs radio resource measurements and provides them to local RRC 204. Based on the information provided by the one or more local RRAs the one or more local RRCs send one or more reports to global RRC 202. A report may be one or more of, but is not limited to a PHY parameter report, a spare capacity report, a contextual report, a data path report, a RRM report, and a HOM report.

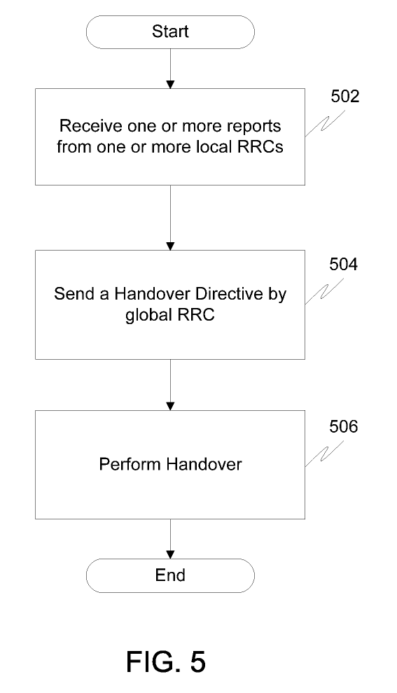

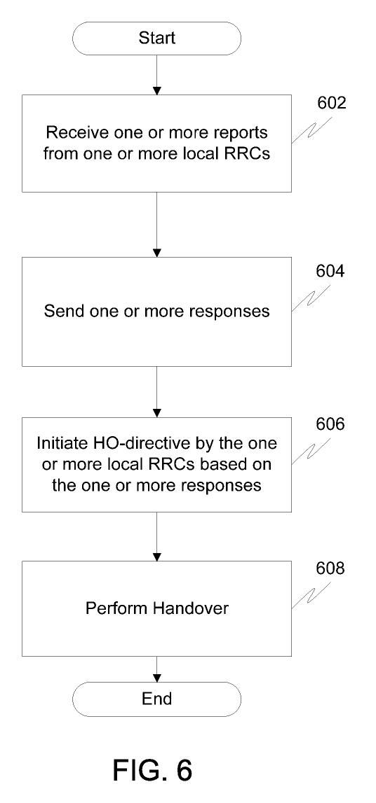

Thereafter, global RRC 202 sends one or more responses to the one or more local RRCs based on the one or more reports received from the one or more local RRCs. In an embodiment of the invention, a response of the one or more responses sent by global RRC 202 includes each of the one or more reports sent by the one or more local RRCs in system 200. For example, global RRC 202 receives spare capacity reports and PHY parameter reports of BS 106 and BS 108 from local RRC 204 and local RRC 208 respectively. Then, global RRC 202 sends a response that includes the spare capacity reports and the PHY parameter reports to the one or more local RRCs in the plurality of BSs. Therefore, global RRC 202 provides a response that includes consolidated information derived from the one or more reports. In another embodiment of the invention, a response of the one or more responses is one of the one or more reports sent by the one or more local RRCs. For example, global RRC 202 sends a response that includes only the spare capacity report of BS 106 to the one or more local RRCs in the plurality of BSs. Thus, global RRC 202 provides a response with specific information derived from the one or more reports. In yet another embodiment of the invention, a response of the one or more responses is a Handover (HO)-Directive, which is provided by global RRC 202. This is further explained in detail in conjunction with FIG. 5 and FIG. 6.

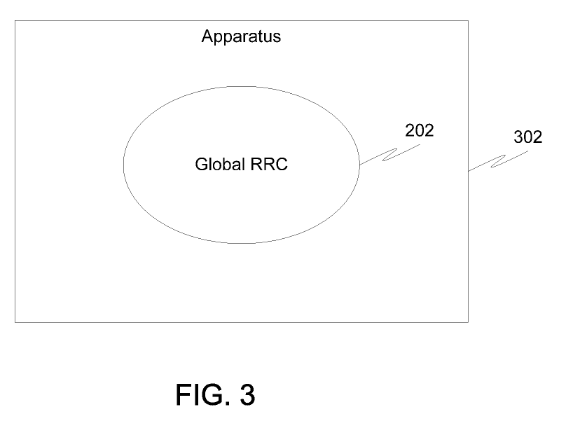

FIG. 3 is a block diagram showing an apparatus 300 for managing communication in wireless communication network 100, in accordance with an embodiment of the invention. Apparatus 300 includes global RRC 202. Global RRC 202 receives one or more reports from one or more local RRCs, such as, local RRC 204, local RRC 206 and local RRC 208. A plurality of BSs in wireless communication network 100, include the one or more local RRCs. The plurality of BSs are operatively coupled to apparatus 300. Thereafter, global RRC 202 sends one or more responses to the one or more local RRCs. This has been explained in detail in conjunction with FIG. 2.

In an embodiment of the invention, apparatus 300 is an ASN-GW, such as, ASN-GW 104. In another embodiment of the invention, apparatus 300 is a master BS. The master BS is selected from the plurality of BSs. For example, BS 110 is selected as the master BS. Therefore, BS 110 includes the global RRC 202. In this case, BS 106 and BS 108 act as slave BSs in wireless communication network 100.

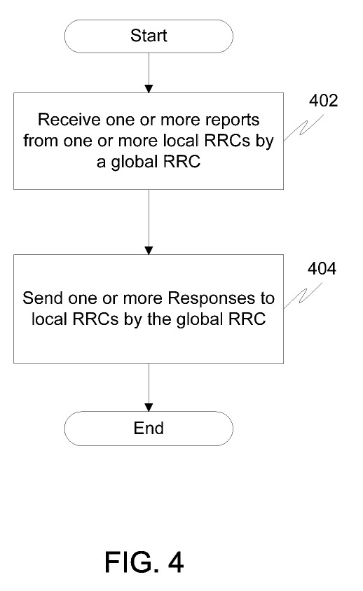

To support HOM by apparatus 300, a response of the one or more responses is a HO-directive generated by global RRC 202. Therefore, if apparatus 300 is an ASN-GW, then the ASN-GW supports the HOM in wireless communication network 100. However, if apparatus 300 is a master BS, then the master BS supports HOM in wireless communication network 100. Alternatively, the one or more local RRCs in the plurality of BSs may generate a HO-directive based on the one or more responses. Therefore, in this case, the one or more local RRCs support HOM in wireless communication network 100. This is further explained in conjunction with FIG. 4.

FIG. 4 is a flowchart of a method for communication is wireless communication network 100, in accordance with an embodiment of the invention. Wireless communication network 100 may correspond to profile C network architecture of a WiMAX communication network. At step 402, global RRC 202 receives one or more reports from one or more local RRCs, such as, local RRC 204, local RRC 206 and local RRC 208. Global RRC 202 may be located in an ASN-GW, such as ASN-GW 104. Alternatively, global RRC 202 may be located in a master BS, which is selected from one of the plurality of BSs. The one or more local RRCs are located in the plurality of BSs. The one or more reports may be one of a PHY parameter report for a BS of the plurality of BSs, a spare capacity report for the BS, a contextual report for the BS, a data path report for the BS, and a handover report for the BS. In an embodiment of the invention, global RRC 202 sends one or more requests to the one or more local RRCs to receive the one or more reports. The one or more requests may be sent periodically by global RRC 202 after a predefined time period. The communication between global RRC 202 and the one or more local RRCs may be relayed through an ASN-GW, such as ASN-GW 104. Alternatively, the communication may be relayed by a relay device located in wireless communication network 100.

As the one or more local RRCs provide the one or more reports to global RRC 202, therefore, global RRC 202 has a global knowledge about wireless communication network 100. In other words, global RRC 202 has information, such as, spare capacity, resource requirement, and handover requirement for the plurality of BSs.

Thereafter, at step 404, global RRC 202 sends one or more responses to the one or more local RRCs. The one or more responses are generated based on the one or more reports. Hence, a response of the one or more responses includes information of the one or more reports received from the one or more local RRCs. A response of the one or more responses may include each of the one or more reports as received from the one or more local RRCs. Alternatively, a response of the one or more responses is one of the one or more reports received from the one or more local RRCs. A response of the one or more responses sent by global RRC 202 may further be a HO-Directive. The HO-directive may be generated based on one or more spare capacity reports and one or more PHY parameter reports received from the one or more local RRCs. This is further explained in detail in conjunction with FIG. 5.

As global RRC 202 receives information, such as, PHY parameter report and spare capacity report, from the one or more local RRCs, therefore, global RRC 202 has the ability to take global decisions based on the information in wireless communication network 100. Additionally, in case wireless communication network 100 is the profile C architecture of a WiMAX communication network, then global RRC 202 provides the profile C architecture of the WiMAX communication network the ability to collect information from the one or more local RRCs and then make global and centralized decisions based on the information.

FIG. 5 is a flowchart of a method for performing handover in wireless communication network 100, in accordance with an embodiment of the invention. At step 502, global RRC 202 receives one or more reports from one or more local RRCs, such as, local RRC 204, local RRC 206, and local RRC 208. This has been explained in detail in conjunction with FIG. 4. The one or more reports may include a spare capacity report and a PHY parameter report.

Based on the one or more reports, global RRC 202 sends a HO-directive to the one or more local RRCs at step 504. It will be apparent to a person skilled in the art that global RRC 202 may send more than one such HO-directive. The HO-directive is a response of the one or more responses sent by global RRC 202. The HO-directive is generated for one or more BS of the plurality of BSs, which include the one or more local RRCs. The HO-directive includes information, such as, type of handover, a reason for handover, ratio of payload for handover, identity of a BS of the plurality of BSs for serving handover, identity of one or more target BSs selected from the plurality of BSs for handover, and identity of one or more MS involved in handover. The information in the HO-directive is computed by global RRC 202 by applying a predefined algorithm on the information derived from the one or more reports received from the one or more local RRCs. The predefined algorithm ensures optimum load balancing and optimum Quality of Service (QOS) in wireless communication network 100.

Thereafter, at step 506, handover of one or more MSs is performed between the plurality of BSs based on the HO-directive. To perform handover of a MS, a serving BS sends a HO-directive response to global RRC 202. Thereafter, a handover of the MS is performed from a serving BS to a target BS. It will be apparent to a person skilled in the art that handover may be performed using any existing methods

As an example for the method given above, in wireless communication network 100, BS 106 has spare capacity for serving two more MSs. However, each of BS 108 (a neighboring BS of the BS 106) and BS 110 (a neighboring BS of the BS 108) has exceeded a predefined serving capacity by two MSs. Therefore, for balancing load between BS 106, BS 108, BS 110 in wireless communication network 100, global RRC 202 in ASN-GW 104 receives PHY parameter reports and spare capacity reports, which include the information about status of BS 106, BS 108, and BS 110 from local RRC 204, local RRC 206, and local RRC 208. Global RRC 202 then applies the predefined algorithm on the PHY parameter reports and the spare capacity reports. Thereafter, based on the result of the application of the predefined algorithm, global RRC 202 sends a first HO-directive to BS 108 and a second HO-directive to BS 110. As global RRC 202 is aware of the status of each of BS 106, BS 108, and BS 110, therefore, the first HO-directive includes the information of handover of one MS from BS 108 to BS 106. Similarly, the second HO-directive includes the information of handover of one MS from BS 110 to BS 106. As a result of this, optimum load balancing is achieved as each of BS 108 and BS 110 are able to handover one MS to BS 106, which had a capacity to serve two additional MSs. In the absence of global RRC 202, which has the global knowledge, a handover of two MSs from each of BS 108 and BS 110 to BS 106 may have been performed, which would have overloaded BS 106.

As global RRC 202 receives PHY parameter reports and spare capacity reports from the one or more local RRCs, global RRC 202 has information about current load on the plurality of BSs. Therefore, by applying the predefine algorithm on the PHY parameter reports and spare capacity reports, global RRC 202 is able to make a centralized decision for load balancing in wireless communication network 100. As a result of this centralized decision, handover from one or more BSs in wireless communication network 100 do not result in overloading the BS.

FIG. 6 is a flowchart of a method for performing handover in wireless communication network 100, in accordance with another embodiment of the invention. At step 602, global RRC 202 receives one or more reports from one or more local RRCs, such as, local RRC 204, local RRC 206, and local RRC 208. This has been explained in detail in conjunction with FIG. 4 and FIG. 5. The one or more reports may include one or more of a PHY parameter report and a spare capacity report.

At step 604, global RRC 202 sends a response to the one or more of local RRCs. The response sent by global RRC 202 may includes each PHY parameter report and each spare capacity report sent by the one or more local RRCs in wireless communication network 100. Therefore, the response includes global knowledge regarding about the status of the plurality of BSs in wireless communication network 100. As the response is sent to the one or more local RRC, therefore, the one or more local RRCs have global knowledge about the status of the plurality of BSs.

At step 606, each of the one or more local RRCs initiate a HO-directive based on the response received from global RRC 202. To initiate a HO-directive, each of the one or more local RRCs applies the predefined algorithm on information derived from the response. As the predefined algorithm used by each of the one or more local RRCs is the same and each of the one or more local RRCs has the global knowledge about the status of the plurality of BSs, therefore, each of the one or more local RRCs derive a unanimous result for initiating a HO-directive in wireless communication network 100.

Thereafter, at step 608, the one or more local RRCs perform handover of one or more MSs between the plurality of BSs based on a HO-directive generated by each of the one or more local RRCs. This has been explained in detail in conjunction with FIG. 5.

Referring back to the example given in FIG. 5, global RRC 202 sends a response to each of local RRC 204, local RRC 206, and local RRC 208. The response includes the PHY parameter reports and the spare capacity reports. Thereafter, each of the local RRC 204, local RRC 206, and local RRC 208 applies the predefined algorithm on the PHY parameter reports and the spare capacity reports. As the predefined algorithm used by each of local RRC 204, local RRC 206, and local RRC 208 is the same, therefore, a HO-directive initiated by each of local RRC 204, local RRC 206, and local RRC 208 is unanimous. Thereafter, local RRC 206 initiates a first HO-directive for BS 108 and local RRC 208 initiates a second HO-directive for BS 110. The first HO-directive includes the information of handover of one MS from BS 108 to BS 106. Similarly, the second HO-directive includes the information of handover of one MS from BS 110 to BS 106. Thereby, avoiding overloading BS 106 as a result of handover management.

Various embodiments of the invention provide method, system and apparatus for communication in a wireless communication network using a global RRC. The global RRC receives reports from one or more local RRC, which are located in a plurality of BSs. Therefore, global RRC has the information regarding the status of the plurality of BSs. This enables the global RRC to take centralized decisions for RRR and HOM in the wireless communication network. As a result of this, the possibility of un-proportionate handover between the plurality of BSs, which may result into overloading a BS, is reduced considerably. Additionally, the invention enables the profile C architecture of a WiMAX communication network to perform RRM and HOM in a centralized manner. Further, the possibility of overloading the ASN-GW due to exchange of messages with the plurality of BSs is reduced as the global RRC can be located in any network entity in the wireless communication network.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. In a wireless communication network having an Access Service Network Gateway (ASN-GW) communicating with a plurality of Base Stations (BS), a method of communicating in the wireless communication network, the method comprising:
receiving at least one report from at least one local Radio Resource Controller (RRC) by a global RRC; and
sending at least one response to each of the at least one local RRC by the global RRC, wherein the at least one response corresponds to the at least one report received from the at least one local RRC.

2. The method of claim 1, wherein the global RRC is located in the ASN-GW.

3. The method of claim 1, wherein the global RRC is located in a master BS, the master BS is selected from the plurality of BSs.

4. The method of claim 1, wherein the at least one local RRC is located in the plurality of BSs.

5. The method of claim 1, wherein the wireless communication network corresponds to Profile C network architecture of a Worldwide Interoperability Microwave Access (WiMAX) communication network.

6. The method of claim 1, wherein a report of the at least one report is a spare capacity report for a BS of the plurality of BSs.

7. The method of claim 1, wherein a report of the at least one reports is a PHY parameter report for a BS of the plurality of BSs.

8. The method of claim 1, wherein a response of the at least one response comprises information of the at least one report received from the at least one local RRC.

9. The method of claim 8, wherein the response provides information corresponding to Radio Resource Management (RRM) in the wireless communication network.

10. The method of claim 8, wherein the response provides information corresponding to the status of at least one of the plurality of BSs.

11. The method of claim 1 further comprises performing hand-over of at least one MS between the plurality of BSs, the hand-over being performed based on a response of the at least one response sent by the global RRC.

12. The method of claim 11, wherein the response is a Handover (HO)-directive for at least one of the plurality of BSs in the wireless communication network.

13. The method of claim 11, wherein the hand-over is performed by initiating a HO-directive by at least one of the local RRCs, the hand-over is initiated based on the response.

14. The method of claim 1, wherein the wireless communication network is one of a WiMAX communication network, 3rd Generation Partnership Project (3GPP) Long Term Evolution (LTE) network, 3rd Generation Partnership Project 2 (3GPP2) Ultra Mobile Broadband (UMB) network, Wireless Fidelity (WiFi) network, and Orthogonal Frequency Division Multiple Access (OFDMA) communication network having a backhaul link.

15. In a wireless communication network having an Access Service Network Gateway (ASN-GW) communicating with a plurality of Base Stations (BS), a system for communication in the wireless communication network, the system comprising::
at least one local Radio Resource Controllers (RRC), wherein each of the at least one local RRC is configured to send at least one report; and
a global RRC configured to:
receive the at least one report from the at least one local RRC; and
send at least one response to each of the at least one RRC, wherein the at least one response corresponds to the at least one report.

16. The system of claim 15 further comprising at least one Radio Resource Agent (RRA) operatively coupled to the at least one local RRC, each of the at least one local RRC and the at least one RRA are located in the plurality of BSs.

17. The system of claim 15, wherein the global RRC is located in the ASN-GW.

18. The system of claim 15, wherein the global RRC is located in one of the plurality of BSs.

19. An apparatus for managing communication in a wireless communication network, the apparatus comprising:
a global Radio Resource Controller (RRC) configured to:
receive at least one report from at least one local RRC, wherein the at least one local RRC is located in the plurality of Base Stations (BSs) located in the wireless communication network, wherein the plurality of BSs are operatively coupled to the apparatus; and
send at least one response to the at least one local RRC, wherein the response corresponds to the at least one report received from the at least one local RRC.

20. The apparatus of claim 19, wherein the apparatus is an Access Service Network Gateway (ASN-GW).

21. The apparatus of claim 19, wherein a response of the at least one response is a Handover (HO)-Directive generated by the global RRC for at least one of the plurality of BSs based on one of the at least one response.

22. The apparatus of claim 19, wherein the apparatus is a master BS.

23. The apparatus of claim 19, wherein the at least one local RRC is configured to generate HO-Directive in the wireless communication network based on one of the at least one response.
